(19) United States
(12) Patent Application Publication
(10) Pub. No.: US 2023/0319175 A1
(43) Pub. Date: Oct. 5, 2023

(54) HANDS-FREE DEVICE

(71) Applicant: Panasonic Intellectual Property Management Co., Ltd., Osaka (JP)

(72) Inventors: Yuto KODANI, KANAGAWA KEN (JP); Koji KUDO, KANAGAWA KEN (JP); Keiji MIURA, TOCHIGI KEN (JP); Takanori MATSUMOTO, KANAGAWA KEN (JP); Mikako YAMAGUCHI, TOKYO TO (JP)

(73) Assignee: Panasonic Intellectual Property Management Co., Ltd., Osaka (JP)

(21) Appl. No.: 18/101,393

(22) Filed: Jan. 25, 2023

(30) Foreign Application Priority Data
Mar. 30, 2022 (JP) 2022-056469

(51) Int. Cl. H04M 1/60; H04M 1/72463; H04M 1/72469; H04M 3/44

(52) U.S. Cl. CPC H04M 1/6083; H04M 1/724631; H04M 1/72469; H04M 3/44

(57) ABSTRACT

An in-vehicle hands-free device includes a memory, and a hardware processor coupled to the memory. The hardware processor is configured to: connect to a mobile phone; acquire incoming call history data of the mobile phone connected by the hardware processor; detect a traveling state of a vehicle on which the in-vehicle hands-free device is mounted; and when accepting a request to output the incoming call history data, output the incoming call history data by voice when detecting that the vehicle is traveling, and output the incoming call history data by display when detecting that the vehicle is not traveling.

### CROSS-REFERENCE TO RELATED APPLICATIONS

This application is based upon and claims the benefit of priority from Japanese Patent Application No. 2022-056469, filed on Mar. 30, 2022, the entire contents of which are incorporated herein by reference.

### FIELD

Embodiments described herein relate generally to a hands-free device.

### BACKGROUND

Conventionally, known is a hands-free device configured to establish a communication line with a mobile phone to enable a user to receive and make a call without directly operating the mobile phone. Such a hands-free device is mounted on, for example, a vehicle and is used when a user has a conversation on the mobile phone while driving.

In addition, there is known a technique of transferring phone book data and outgoing call history data or incoming call history data from the mobile phone to the hands-free device.

Some of such hands-free devices display the incoming call history data in response to a user instruction (for example, refer to JP 6599380 B2).

However, in the related art, sufficient consideration is not given to an output mode of an incoming call history while a vehicle is traveling.

The present disclosure provides a hands-free device capable of appropriately outputting and controlling an incoming call history while a vehicle is traveling.

### SUMMARY

An in-vehicle hands-free device according to the present disclosure includes a memory, and a hardware processor coupled to the memory. The hardware processor is configured to: connect to a mobile phone; acquire incoming call history data of the mobile phone connected by the hardware processor; detect a traveling state of a vehicle on which the in-vehicle hands-free device is mounted; and when accepting a request to output the incoming call history data, output the incoming call history data by voice when detecting that the vehicle is traveling, and output the incoming call history data by display when detecting that the vehicle is not traveling.

### BRIEF DESCRIPTION OF THE DRAWINGS

FIG. 1 is a view illustrating an example of a use form of a hands-free device according to the present embodiment;

FIG. 2 is a diagram illustrating an example of a hardware configuration of the hands-free device according to the present embodiment;

FIG. 3 is a diagram illustrating an example of functions provided in the hands-free device according to the present embodiment; and

FIG. 4 is a flowchart illustrating an output processing procedure for an incoming call history according to the present embodiment.

### DETAILED DESCRIPTION

Hereinafter, an embodiment of a hands-free device according to the present disclosure will be described with reference to the drawings.

### Embodiment

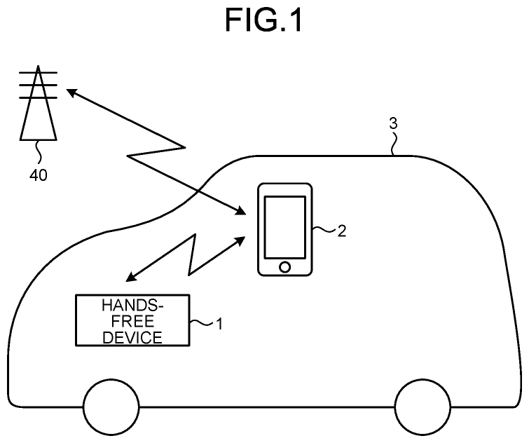

FIG. 1 is a view illustrating an example of a use form of a hands-free device 1 according to the present embodiment. As illustrated in FIG. 1, the hands-free device 1 of the present embodiment can be mounted on a vehicle 3. The hands-free device 1 is communicably connected to a mobile phone 2. In addition, the mobile phone 2 wirelessly communicates with a base station 40 via a mobile phone network. The mobile phone 2 is, for example, a smartphone, and has a communication function based on a Bluetooth (registered trademark) system which is a short-range wireless communication means. Note that the mobile phone 2 may be a mobile phone of a type other than a smartphone as long as the mobile phone 2 has the communication function based on the Bluetooth system.

The hands-free device 1 connects to the mobile phone network via the mobile phone 2. Accordingly, for example, a driver of the vehicle 3 can make and receive calls by operating the hands-free device 1 without operating the mobile phone 2. The hands-free device 1 may be implemented, for example, as one function of an in-vehicle navigation device mounted on the vehicle 3.

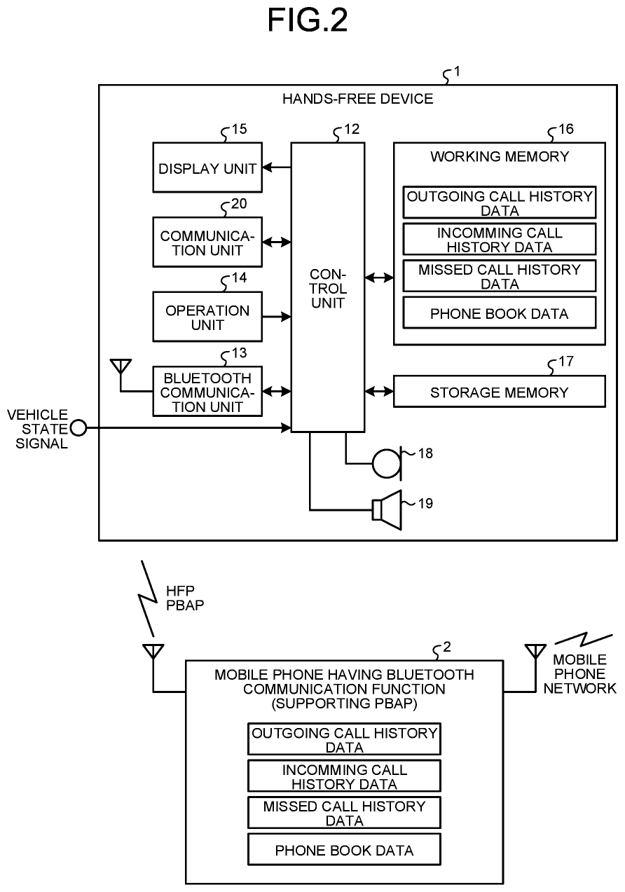

FIG. 2 is a diagram illustrating an example of a hardware configuration of the hands-free device 1 according to the present embodiment. The hands-free device 1 of the present embodiment is, for example, an in-vehicle navigation device having a hands-free function. The hands-free device 1 includes a control unit 12, a Bluetooth communication unit 13, an operation unit 14, a display unit 15, a working memory 16, a storage memory 17, a microphone 18, a speaker 19, and a communication unit 20.

The control unit 12 controls overall operations such as a communication operation and a data management operation of the hands-free device 1. The control unit 12 is, for example, a processor such as a central processing unit (CPU).

The Bluetooth communication unit 13 is compatible with a Bluetooth system, which is a short-range wireless communication means, and establishes a wireless communication line with the mobile phone 2 present within a Bluetooth wireless communication range to perform communication conforming to the Bluetooth communication standard. Note that, in this case, it is assumed that the mobile phone 2 has a Bluetooth communication function and is present within a Bluetooth wireless communication range of the hands-free device 1.

The Bluetooth communication unit 13 according to the present embodiment supports a well-known “hands free profile” (HFP) configured to perform hands-free calls, and a “phone book access profile” (PBAP) configured to transfer phone book data and to transfer outgoing call history data or incoming call history data. These profiles mean communication protocols defined for each function.

As is well known, when the mobile phone 2 is alone (in a state in which it is not connected, with the HFP, to the hands-free device 1 which is a hands-free apparatus), the mobile phone 2 is configured to be able to establish a mobile phone line with the base station 40 of the mobile phone network and independently perform an outgoing call process of the mobile phone and an incoming call process thereof. In this case, as the outgoing call process, for example, when a user operates a dial key (numeric keys of “0” to “9”) (not illustrated) to input a phone number of an outgoing call destination and then operates an outgoing call key (not illustrated), the mobile phone 2 can make a call with the phone number as the outgoing call destination and can make a call with a mobile phone of the outgoing call destination.

In addition, as the incoming call process, when receiving an incoming call signal from the base station 40 in response to the fact that a mobile phone of an outgoing call source makes a call to the mobile phone 2 as an outgoing call destination, the mobile phone 2 receives a phone number of the mobile phone of the outgoing call source as an incoming call phone number from the base station 40, and when the user operates a phone reception key (not illustrated), the mobile phone 2 can respond to the mobile phone of the outgoing call source, thereby making it possible to make a call with the mobile phone of the outgoing call source.

In addition, the mobile phone 2 includes a clock unit (not illustrated) configured to clock date and time, and stores and holds a plurality of pieces of outgoing call history data with a correspondence between an outgoing call phone number input by operating a dial key in the above-described outgoing call process and an outgoing call date and time based on the date and time clocked by the clock unit as one piece of data. In addition, the mobile phone 2 stores and holds a plurality of pieces of incoming call history data with a correspondence between an incoming call phone number received from the base station 40 in the above-described incoming call process and an incoming call date and time based on the date and time clocked by the clock unit as one piece of data.

In addition, the mobile phone 2 stores and holds a plurality of pieces of missed call history data with a correspondence between the incoming call phone number received from the base station 40 when a response is not made to the incoming call and the incoming call date and time based on the date and time clocked by the clock unit as one piece of data. Further, the mobile phone 2 stores and holds a plurality of pieces of phone book data with a correspondence between a phone number and a registered name as one piece of data. In the phone book data, a user inputs the phone number and the registered name, and, for example, approximately 500 phone numbers and registered names are associated with each other and stored in a nonvolatile memory (not illustrated).

When the mobile phone 2 has the phone book data, the outgoing call history data and the incoming call history data include the registered name. Specifically, the incoming call phone number received from the base station 40 is a phone number registered in the phone book data, and the mobile phone 2 checks whether a registered name is registered in the phone book data for this phone number. In a case where the registered name is present therein, the incoming call history data includes the phone number, the incoming call date and time, and the registered name. The missed call history data also includes the phone number, the incoming call date and time, and the registered name thereof with a similar process. The mobile phone 2 also checks whether the phone number to which a call is made in the outgoing call process is a phone number registered in the phone book data for the outgoing call history data. In a case where the phone number is registered in the phone book data, the outgoing call history data includes the outgoing call date and time, the outgoing call phone number, and the registered name thereof.

Then, the user selects one phone number read from the phone book data by the mobile phone 2 and makes a call, so that the user can make a call without fail with a simple operation without inputting all numeric keys corresponding to the numbers constituting the phone number. Note that the mobile phone 2 can store the latest 20 pieces of the outgoing call history data, the incoming call history data, and the missed call history data, respectively. For example, every time an outgoing call process, an incoming call process, or a missed call is performed, the mobile phone 2 automatically deletes the oldest data and updates the outgoing call history data, the incoming call history data, or the missed call history data. The mobile phone 2 supports a well-known HFP configured to perform a hands-free call, and a PBAP configured to transfer the phone book data and to transfer the outgoing call history data or the incoming call history data.

In a case where the mobile phone 2 supports the PBAP that defines automatic transfer of the outgoing call history data or the incoming call history data, it establishes the connection with the PBAP immediately after establishing a communication line with the Bluetooth communication unit 13, automatically transfers the phone book data stored at that time, and further automatically transfers the outgoing call history data, the incoming call history data, and the missed call history data stored at that time. As a result, when the hands-free device 1 is present within the Bluetooth communication range, the mobile phone 2 automatically transfers, to the hands-free device 1, up to 20 pieces of the outgoing call history data stored by independently performing the outgoing call process in the past, up to 20 pieces of the incoming call history data stored by independently performing the incoming call process in the past, and up to 20 pieces of the missed call history data stored by independently performing a missed call process in the past.

In the present embodiment, when the outgoing call history data, the incoming call history data, and the missed call history data are collectively referred to, the same are simply referred to as history data.

The operation unit 14 of the hands-free device 1 is an operation means configured to allow a user to perform an operation in the present embodiment, and includes, for example, a touch key formed on the display unit 15, detects the user's operation, and outputs an operation signal representing an operation content thereof to the control unit 12. The display unit 15 is a display means in the present embodiment. When a display signal is input from the control unit 12, the display unit 15 displays a display screen based on the input display signal, and displays, for example, a display screen on which dial keys corresponding to “0” to “9” are arranged as a display screen on which the user inputs a phone number. The display unit 15 is, for example, a liquid crystal display or an organic electro luminescence (EL) display, but is not limited thereto.

The working memory 16 is an outgoing call history data storage means, an incoming call history data storage means, and a data storage means in the present embodiment, and includes a volatile memory. The working memory 16 stores the outgoing call history data, the incoming call history data, the missed call history data, and the phone book data automatically transferred from the mobile phone 2 without any operation by the user. In this case, the working memory 16 can store, for example, five pieces of the outgoing call history data, the incoming call history data, and the missed call history data, respectively. The working memory 16 is, for example, a random access memory (RAM) or the like.

The storage memory 17 includes a nonvolatile memory and stores various kinds of data. The storage memory 17 is, for example, a read only memory (ROM). Furthermore, the storage memory 17 may be a writable storage medium such as a hard disk drive (HDD) or a flash memory.

The control unit 12 causes the display unit 15 to display the outgoing call history data stored in the working memory 16 when the user makes a request to display the outgoing call history data using the operation unit 14, causes the display unit 15 to display the incoming call history data stored in the working memory 16 when the user makes a request to display the incoming call history data using the operation unit 14, and causes the display unit 15 to display the phone book data stored in the working memory 16 when the user makes a request to display the phone book data using the operation unit 14. In the hands-free device 1 according to the present embodiment, as described above, five pieces of the outgoing call history data and the incoming call history data are stored in the working memory 16, respectively, and the maximum number of items displayed on the display unit 15 is also five pieces each. Note that the number of these pieces of data stored in the working memory 16 is an example, and is not limited to the above example.

The microphone 18 is a voice input means configured to input a voice, and inputs a voice uttered by a user when a hands-free call is performed using the mobile phone 2. The speaker 19 is a voice output means, and outputs a received voice of a calling party when a hands-free call is performed using the mobile phone 2. That is, when the Bluetooth communication line is established between the Bluetooth communication unit 13 and the mobile phone 2 and connection with the wireless communication is established, the control unit 12 causes the Bluetooth communication unit 13 to transmit a voice input by the microphone 18 to the mobile phone 2 to transmit the voice from the mobile phone 2 to the mobile phone network, and causes the Bluetooth communication unit 13 to receive the voice received from the mobile phone network by the mobile phone 2 from the mobile phone 2 to output the voice from the speaker 19.

The communication unit 20 is, for example, a wireless communication apparatus configured to perform short-range wireless communication. The communication unit 20 according to the present embodiment performs short-range wireless communication compatible with Wi-fi as a wireless communication standard. In Wi-fi, communication is performed using frequency bands of a 2.4 GHz band and a 5 GHz band. In the present embodiment, similarly to Bluetooth, the communication unit 20 establishes a wireless communication line with a device present within a Wi-fi communication range using the 2.4 GHz band, and performs communication conforming to the Wi-Fi communication standard. Furthermore, the communication unit 20 may be a communication means using a public line.

Further, the control unit 12 of the hands-free device 1 receives a vehicle state signal from a device in the vehicle. The vehicle state signal includes a signal indicating a traveling state of the vehicle. The signal indicating the traveling state of the vehicle is a signal capable of determining whether or not the vehicle is traveling, such as a signal indicating a traveling speed of the vehicle output from a speed sensor.

The vehicle state signal may further include a signal capable of determining the number of occupants in the vehicle. As a signal capable of determining the number of occupants in the vehicle, there are a signal output from a seating sensor, a signal output from a weight sensor, and the like.

Note that the above-described hands-free device 1 may be configured to include, in addition to the illustrated functional blocks, functional blocks necessary for navigation operations, such as a GPS device as a current position detection unit configured to detect a current position of an own vehicle, a route search unit configured to search for a route from the current position to a destination, a map data reading unit configured to read map data from a recording medium in which the map data is recorded, a VICS information reception unit configured to receive VICS information distributed from a VICS (registered trademark) center, and a voice recognition unit configured to recognize a voice uttered by a user. In this case, the hands-free device 1 may extract GPS date and time information from a GPS wireless signal received by the GPS device from a GPS satellite to acquire date and time, and may use the acquired date and time as an outgoing call date and time or an incoming call date and time.

The above-described hands-free device 1 is configured to be activated/stopped in conjunction with on/off of an ACC switch (a switch configured to turn on/off power supply to a vehicle apparatus). In the hands-free device 1, for example, when the ACC switch is switched from on to off in response to an operation by a user, the power supply is stopped, and as a result, the device power is shifted from on to off. In this case, various kinds of data stored in the storage memory 17 are not erased immediately before the device power is shifted from on to off (various kinds of data are stored and held therein), but the outgoing call history data, the incoming call history data, the missed call history data, and the phone book data stored in the working memory 16 are configured to be erased immediately before the device power is shifted from on to off.

Next, details of the control unit 12 will be described.

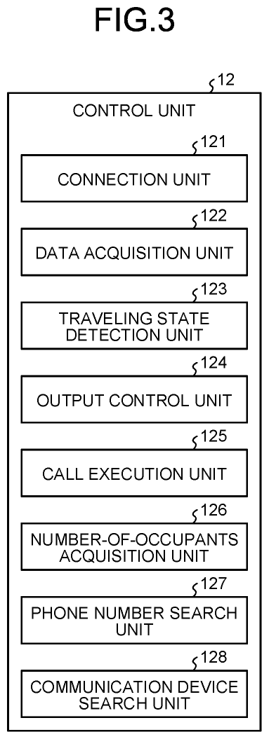

FIG. 3 is an example of a functional block diagram of the control unit 12. The control unit 12 includes a connection unit 121, a data acquisition unit 122, a traveling state detection unit 123, an output control unit 124, a call execution unit 125, a number-of-occupants acquisition unit 126, a phone number search unit 127, and a communication device search unit 128.

The connection unit 121, the data acquisition unit 122, the traveling state detection unit 123, the output control unit 124, the call execution unit 125, the number-of-occupants acquisition unit 126, the phone number search unit 127, and the communication device search unit 128 are implemented by, for example, one or a plurality of processors. For example, each of the above-described units may be implemented by causing a processor such as a central processing unit (CPU) to execute a program, that is, by software. Each of the above-described units may be implemented by a processor such as a dedicated integrated circuit (IC), that is, by hardware. Each of the above-described units may be implemented using software and hardware in combination. When the plurality of processors are used, each of the plurality of processors may implement one of a plurality of units, or may implement two or more of the plurality of units.

The processor reads and executes the program stored in the storage memory 17 to implement each of the plurality of units. Instead of storing the program in the storage memory 17, the program may be directly incorporated in a circuit of the processor. In this case, the processor implements each of the plurality of units by reading and executing the program incorporated in the circuit.

The connection unit 121 executes a hands-free connection process of establishing wireless communication connection with the mobile phone 2 using the HFP. The hands-free connection process is a process of establishing wireless communication connection with the mobile phone 10 using the HFP. That is, connection with the HFP between the hands-free device 1 and the mobile phone 2 is established by the connection unit 121.

When the connection with the HFP is established, the hands-free device 1 enters a state in which a hands-free call via the mobile phone 2 can be performed. Specifically, the connection unit 121 transmits a voice received from the microphone 18 to the mobile phone 2 via the Bluetooth communication unit 13. The mobile phone 2 transmits the voice received from the hands-free device 1 to the mobile phone 2 of an outgoing call destination phone number via the base station 40. Further, the connection unit 121 receives a voice received by the mobile phone 2 from another mobile phone via the Bluetooth communication unit 13 and outputs the voice to the speaker 19. Therefore, the hands-free device 1 can perform a hands-free call. In the present embodiment, the wireless communication connection using the HFP may be referred to as connection with the HFP or HFP connection for the description thereof. When detecting a plurality of mobile phones 2, the connection unit 121 is set to connect to one mobile phone 2 among the plurality of mobile phones 2. As a result, the hands-free device 1 can determine the mobile phone 2 to be connected to the hands-free device 1. When the call execution unit 125 to be described later executes a call due to an incoming call by the mobile phone 2, the connection unit 121 transmits incoming call history data resulting from the call to the mobile phone 2. That is, the connection unit 121 is an example of a transmission unit. As a result, the hands-free device 1 can reflect the incoming call history data when the hands-free device 1 is connected to the mobile phone 2 on the mobile phone 2.

The data acquisition unit 122 acquires the incoming call history data of the mobile phone 2 connected by the connection unit 121. The incoming call history data may include presence or absence of a response. In addition, the incoming call history data may include accompanying information on any of the number of incoming calls, duration of a call, and a time slot during which the call is made.

The data acquisition unit 122 may acquire incoming call history data selected by a user operation among the incoming call history data stored in the mobile phone 2. In this case, the hands-free device 1 can output only the incoming call history data required by the user, and can easily select the incoming call history data of an outgoing call target. In addition, the data acquisition unit 122 may store information indicating whether or not the incoming call history data of the mobile phone 2 is selected by the user operation, and may not acquire the unselected incoming call history data from the next time. In this case, since the hands-free device 1 does not display unnecessary incoming call history data, convenience can be improved. The data acquisition unit 122 may acquire a message by a short message service from the mobile phone 2. The data acquisition unit 122 may acquire phone book data. In addition, the data acquisition unit 122 may acquire a battery amount of the mobile phone 2. Accordingly, the hands-free device 1 can transmit the battery amount to a user (for example, a driver). In addition, the hands-free device 1 can promote recharging in a case where the battery amount is small.

The traveling state detection unit 123 detects a traveling state of the vehicle 3 on which an own device is mounted. The traveling state detection unit 123 acquires a sensor signal of a speed sensor as a vehicle state signal, and detects the traveling state of the vehicle 3 based on the speed indicated by the sensor signal.

The output control unit 124 outputs various kinds of data such as incoming call history data to the display unit 15 or the speaker 19. Specifically, upon accepting a request to output the incoming call history data, the output control unit 124 outputs the incoming call history data to the speaker 19 by voice when the traveling state detection unit 123 detects that the vehicle 3 is traveling, and outputs the incoming call history data by display by outputting it to the display unit 15 when the traveling state detection unit 123 detects that the vehicle 3 is not traveling. In addition, when outputting the incoming call history data to the display unit 15, the output control unit 124 may output an icon indicating presence or absence of a response by display. As a result, the hands-free device 1 can output information indicating presence or absence of a response in a format that is easy for the user to understand.

When outputting the incoming call history data to the speaker 19, the output control unit 124 preferentially outputs incoming call history data to which a response is not made by voice. For example, the output control unit 124 may output only incoming call history data to which the response is not made by voice, or may output incoming call history data to which the response is made by voice after outputting the incoming call history data to which the response is not made by voice. As a result, since the presence or absence of a response is known by a voice notification, the hands-free device 1 can safely notify the user of the presence or absence of a response because the user does not need to look at the screen.

In a case where the mobile phone 2 receives an incoming call and the call execution unit 125 to be described later executes the call, the output control unit 124 may output a phone bill for the call by voice. As a result, the hands-free device 1 can notify the user of the phone bill without causing the user to look at the phone bill.

When the data acquisition unit 122 acquires the incoming call history data including the accompanying information, and the output control unit 124 accepts a request to output the incoming call history data, the output control unit 124 may output the incoming call history data by display such that the incoming call history data are rearranged based on the accompanying information of the incoming call history data when the traveling state detection unit 123 detects that the vehicle 3 is not traveling. As a result, the hands-free device 1 can output the incoming call history data by display in a format that is easy for the user to understand.

In addition, when the number of occupants in the vehicle 3 is plural, the output control unit 124 may perform a predetermined restriction such as not outputting the incoming call history data. The output control unit 124 determines whether or not the number of occupants in the vehicle 3 is plural based on information acquired by the number-of-occupants acquisition unit 126. Accordingly, the hands-free device 1 can prevent contents of the incoming call history data from being known to anyone other than the user.

In addition, in a case where the output control unit 124 acquires a message from the mobile phone 2, when the traveling state detection unit 123 detects that the vehicle 3 is traveling, the output control unit 124 may output the message to the speaker 19 by voice, and when the traveling state detection unit 123 detects that the vehicle 3 is not traveling, the output control unit 124 may output the message by display by outputting it to the display unit 15. The message is a so-called short mail, an electronic mail, or the like. Accordingly, the hands-free device 1 can output contents of the message in an output mode that is safe and easy for the user to understand depending on the traveling state of the vehicle 3.

In addition, in a case where the mobile phone 2 receives an incoming call and the call execution unit 125 to be described later fails to execute a call, the output control unit 124 may output that the response has failed, by voice when the traveling state detection unit 123 detects that the vehicle 3 is traveling, and may output that the response has failed, by display when the traveling state detection unit 123 detects that the vehicle 3 is not traveling. As a result, the hands-free device 1 can output that the response has failed in the output mode that is safe and easy for the user to understand.

In addition, in a case where the mobile phone 2 receives an incoming call and the call execution unit 125 to be described later fails to execute a call, the output control unit 124 may output that the response has failed, by voice when the traveling state detection unit 123 detects that the vehicle 3 is in a parking state. As a result, the hands-free device 1 can output that the response has failed at a safe timing for the user.

Further, when displaying and outputting the incoming call history data, the output control unit 124 may pop up the incoming call history data when another application is being displayed. As a result, the hands-free device 1 can notify the user that there is an incoming call even when another application is being executed.

In addition, the output control unit 124 may output a battery amount of the mobile phone 2 by voice or by display. Accordingly, the hands-free device 1 can notify the user of the battery amount. For example, the hands-free device 1 can encourage the user to recharge the battery by indicating that the battery amount is small.

When the mobile phone 2 receives an incoming call, the call execution unit 125 executes a call. In addition, the call execution unit 125 may accept an incoming call only when an incoming call source is of a phone number set to that its incoming call is enabled in the phone book data. As a result, it is possible to case the hands-free device 1 to receive an incoming call only when the incoming call source is known.

Further, the call execution unit 125 may reject an incoming call when the incoming call source does not correspond to the phone book data. In this case, since the hands-free device 1 does not accept an incoming call from a phone number not registered in the phone book data, it is possible to prevent the hands-free device 1 from receiving an incoming call that may be unnecessary for the user. Accordingly, it is possible to allow the user to concentrate on driving.

The number-of-occupants acquisition unit 126 acquires the number of occupants in the vehicle 3. For example, the number-of-occupants acquisition unit 126 may acquire information on the number of occupants based on an analysis result of data of image captured by a camera in the vehicle 3 as a vehicle state signal.

The phone number search unit 127 searches for a phone number not included in the phone book data among the phone numbers in the incoming call history data. The phone number search unit 127 executes phone number search via the communication unit 20. In this case, the hands-free device 1 can acquire information on a calling party by searching for a phone number not registered in the phone book data.

When the traveling state detection unit 123 detects that the vehicle 3 is not traveling, the communication device search unit 128 searches for a wireless communication device outside the vehicle, and outputs a search result thereof by display. In this case, the hands-free device 1 can output the search result of the wireless communication device outside the vehicle at a safe timing for the user.

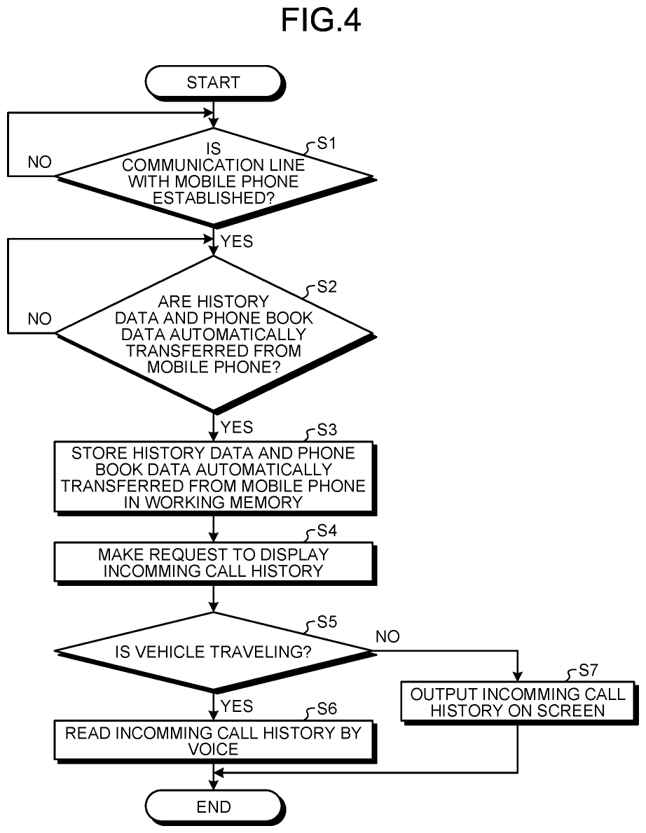

Next, an output processing procedure for the incoming call history of the hands-free device 1 will be described with reference to FIG. 4. First, when the connection unit 121 establishes a communication line with the mobile phone 2 (Step S1: Yes), the process proceeds to Step S2. In Step S2, when the data acquisition unit 122 acquires history data and phone book data from the mobile phone 2 via the connection unit 121 by automatic transfer (Step S2: Yes), the history data and the phone book data are registered in the working memory 16 (Step S3).

When a user makes a request to display the incoming call history data (Step S4), the process proceeds to Step S5. When a detection result by the traveling state detection unit 123 indicates that the vehicle 3 is traveling (Step S5: Yes), the output control unit 124 outputs the incoming call history data by voice (Step S6). When the detection result by the traveling state detection unit 123 indicates that the vehicle 3 is not traveling (Step S5: No), the output control unit 124 outputs the incoming call history data by display (Step S7).

In the hands-free device 1 according to the present embodiment, the connection unit 121 connects to the mobile phone 2, the data acquisition unit 122 acquires the incoming call history data, and the traveling state detection unit 123 detects the traveling state of the vehicle 3. Upon accepting a request to output the incoming call history data, the output control unit 124 outputs the incoming call history data to the speaker 19 by voice when the traveling state detection unit 123 detects that the vehicle 3 is traveling, and displays and outputs the incoming call history data to the display unit 15 when the traveling state detection unit 123 detects that the vehicle 3 is not traveling.

As described above, the hands-free device 1 outputs the incoming call history data by voice when the vehicle 3 is traveling, and outputs the incoming call history data by display when the vehicle 3 is not traveling, thereby making it possible to avoid urging the user to perform inattentive driving by outputting the incoming call history data by display even though the vehicle 3 is traveling. That is, the hands-free device 1 can appropriately output and control the incoming call history data while the vehicle 3 is traveling.

Although the embodiments of the present disclosure have been described above, the above-described embodiments have been presented as examples, and are not intended to limit the scope of the invention. These novel embodiments can be implemented in various other forms, and various omissions, substitutions, and changes can be made without departing from the gist of the invention. These novel embodiments and modifications thereof are included in the scope and gist of the invention, and are included in the invention described in the claims and the equivalent scope thereof. Furthermore, the components of different embodiments and modifications may be appropriately combined.

In addition, the notation of the “ . . . unit” in the above-described embodiments may be replaced with another notation such as “ . . . circuitry”, “ . . . assembly”, “ . . . device”, “ . . . unit”, or “ . . . module”.

In each of the above embodiments, the present disclosure has been described as an example of a configuration using hardware, but the present disclosure can also be implemented by software in cooperation with hardware.

Each functional block used in the description of each embodiment described above is typically implemented as an LSI which is an integrated circuit. The integrated circuit may control each functional block used in the description of the above embodiment and include an input terminal and an output terminal. These may be individually integrated into one chip, or may be integrated into one chip so as to include a part or all of them. Although the LSI is used herein, the LSI may be referred to as an IC, a system LSI, a super LSI, or an ultra LSI depending on the degree of integration.

In addition, a circuit integration method is not limited to the LSI, and may be implemented using a dedicated circuit or a general-purpose processor and a memory. A field programmable gate array (FPGA) capable of being programmed after manufacturing of the LSI or a reconfigurable processor in which connections or settings of circuit cells inside the LSI can be reconfigured may be used.

Further, when circuit integration technology replacing the LSI appears due to the progress of semiconductor technology or another derived technology, the functional blocks may be integrated using the technology. Application of biotechnology and the like is possible.

Furthermore, the effects of the embodiments described in the present specification are merely examples and are not limited, and other effects may be obtained.

According to an in-vehicle hands-free device according to the present disclosure, it is possible to appropriately output and control an incoming call history while a vehicle is traveling.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An in-vehicle hands-free device comprising:
a memory; and
a hardware processor coupled to the memory,
the hardware processor being configured to:
connect to a mobile phone;
acquire incoming call history data of the mobile phone connected by the hardware processor;
detect a traveling state of a vehicle on which the in-vehicle hands-free device is mounted; and
when accepting a request to output the incoming call history data, output the incoming call history data by voice when detecting that the vehicle is traveling, and output the incoming call history data by display when detecting that the vehicle is not traveling.

2. The in-vehicle hands-free device according to claim 1, wherein the hardware processor is configured to:
acquire the incoming call history data including presence or absence of a response; and
output an icon indicating the presence or absence of the response by display when outputting the incoming call history data by display.

3. The in-vehicle hands-free device according to claim 1, wherein the hardware processor is configured to:
acquire the incoming call history data including presence or absence of a response; and
preferentially output incoming call history data to which the response is not made, by voice when outputting the incoming call history data by voice.

4. The in-vehicle hands-free device according to claim 1, wherein
the hardware processor is further configured to execute a call when the mobile phone receives an incoming call, and
the hardware processor is configured to output a phone bill for the call by voice when detecting that the vehicle is traveling.

5. The in-vehicle hands-free device according to claim 1, wherein the hardware processor is configured to acquire selected incoming call history data among the incoming call history data of the mobile phone.

6. The in-vehicle hands-free device according to claim 5, wherein the hardware processor is configured to not acquire unselected incoming call history data among the incoming call history data of the mobile phone from next time.

7. The in-vehicle hands-free device according to claim 1, wherein the hardware processor is configured to:
acquire the incoming call history data including accompanying information on any of the number of incoming calls, duration of a call, and a time period during which a call is made; and
when accepting a request to output the incoming call history data, output the incoming call history data by display such that the incoming call history data are rearranged based on accompanying information of the incoming call history data, when detecting that the vehicle is not traveling.

8. The in-vehicle hands-free device according to claim 1, wherein
the hardware processor is further configured to acquire a number of occupants in the vehicle, and
the hardware processor is configured to restrict output processing for the incoming call history data when the number of occupants acquired by the hardware processor is plural.

9. The in-vehicle hands-free device according to claim 1, wherein the hardware processor is configured to:
acquire a message by a short message service from the mobile phone; and
when acquiring the message, output the message by voice when detecting that the vehicle is traveling, and output the message by display when detecting that the vehicle is not traveling.

10. The in-vehicle hands-free device according to claim 1, wherein
the hardware processor is configured to acquire phone book data, and
the hardware processor is further configured to search for a phone number not included in the phone book data among phone numbers in the incoming call history data.

11. The in-vehicle hands-free device according to claim 1, wherein the hardware processor is further configured to:
execute a call when the mobile phone receives an incoming call; and
transmit incoming call history data resulting from the call to the mobile phone.

12. The in-vehicle hands-free device according to claim 11, wherein the hardware processor is configured to, when failing to execute the call, output that a response has failed, by voice when detecting that the vehicle is traveling, and output that the response has failed, by display when detecting that the vehicle is not traveling.

13. The in-vehicle hands-free device according to claim 11, wherein the hardware processor is configured to, when failing to execute the call, output that a response has failed, by voice when detecting that the vehicle is in a parking state.

14. The in-vehicle hands-free device according to claim 1, wherein
the hardware processor is further configured to execute a call when the mobile phone receives an incoming call, and
the hardware processor is configured to
acquire phone book data; and
accept an incoming call only from an incoming call source having its incoming call enabled, in the phone book data.

15. The in-vehicle hands-free device according to claim 1, wherein the hardware processor is set to connect to one of a plurality of mobile phones when detecting the plurality of mobile phones.

16. The in-vehicle hands-free device according to claim 1, wherein the hardware processor is configured to, when outputting the incoming call history data by display, pop up the incoming call history data when another application is being displayed.

17. The in-vehicle hands-free device according to claim 1, wherein the hardware processor is configured to:
acquire a battery amount of the mobile phone; and
output the battery amount of the mobile phone.

18. The in-vehicle hands-free device according to claim 1, wherein the hardware processor is further configured to execute a call when the mobile phone receives an incoming call, and
the hardware processor is configured to:
acquire phone book data; and
when the mobile phone receives an incoming call, reject the incoming call when an incoming call source does not correspond to the phone book data.

19. The in-vehicle hands-free device according to claim 1, wherein the hardware processor is further configured to search for a wireless communication device outside the vehicle and output a search result by display when detecting that the vehicle is not traveling.
